(19) United States
(12) Patent Application Publication
(10) Pub. No.: US 2026/0181074 A1
(43) Pub. Date: Jun. 25, 2026

(54) Device and Method for Securing Recordable Call Conversations

(71) Applicant: MOTOROLA SOLUTIONS, INC., CHICAGO, IL (US)

(72) Inventors: PAWEL WILKOSZ, WISNIOWA (PL); RADOSLAW KRZYCH, KRAKOW (PL); MICHAL WILK, USCIE SOLNE (PL); KONRAD D. GRON, MUSZYNA (PL); DAWID STRACILO, CRACOW (PL)

(21) Appl. No.: 18/987,471

(22) Filed: Dec. 19, 2024

(51) Int. Cl. H04M 3/42

(52) U.S. Cl. CPC H04M 3/42221; H04M 2203/301; H04M 2203/6009

(57) ABSTRACT

A process for securing externally recordable conversations exchanged during the call. In operation, an electronic computing device receives a notification indicating that a call has been initiated from a first communication device to a second communication device. The electronic computing device determines that conversations exchanged during the call are recordable by at least one recording device external to the first and second communication devices. The electronic computing device identifies a security policy to be applied to the call between the first and the second communication devices. The electronic computing device determines, from the security policy, that there is a need to secure recording of conversations exchanged between the first and second communication devices during the call. The electronic computing device secures the conversations recordable by the at least one recording device by modifying a recording function associated with the at least one recording device for a duration of the call.

### BACKGROUND

When engaging in video or audio calls, it is not uncommon for cameras and microphones situated close to the caller or the callee to capture and record the conversations taking place. These recordings, which can encompass a wide range of personal and sensitive information, are often stored in digital formats that can be accessed at a later time. Consequently, without proper safeguards, there exists a potential for such recordings to be replayed and scrutinized by individuals who gain access to them, whether they are authorized users or not. The implications of this are vast, impacting personal privacy, data security, and raising significant concerns about the misuse of confidential conversations in various contexts.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a system in accordance with some embodiments.

FIG. 2 is a block diagram of an electronic computing device shown in FIG. 1 in accordance with some embodiments.

FIG. 3 illustrates a flowchart of a process for securing recordable call conversations in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Cameras and microphones located in proximity to parties participating in a call can record call conversations. There is a potential for misuse as these recorded conversations can be exploited by unauthorized users who may access, distribute, or manipulate the conversations. Calls vary significantly in terms of security, especially when considering the context in which they occur. For example, talk group calls associated with public-safety agencies or sensitive governmental operations are often held to a higher standard of security compared to routine, everyday communications. The parties involved in these specialized calls operate under the expectation that their dialogue is not just confidential but also protected by layers of encryption. This is a critical requirement for such agencies, where the secure transmission of information is paramount to their operations. Whether discussing tactical plans, sharing privileged information, or coordinating emergency responses, these calls are secured with advanced security measures to prevent any possibility of eavesdropping or data breaches. This level of discretion in applying security policies underscores the agency's recognition that different conversations warrant varying degrees of protection, tailored to the sensitivity and importance of the information being exchanged. However, recording devices such as cameras and microphones located externally from the devices participating in a call are not configured to be aware of the security policies implemented for securing a call between the devices. Since conventional recording devices are not aware of the security policies implemented by agencies for securing a call, these policies are not enforced at the recording devices. The recording devices are therefore free to record and digitally store call conversations between parties participating in a call even. There is a possibility for such digitally stored call conversations to be accessed, distributed, and manipulated by unauthorized users. Thus, there exists a need for an improved technical method and device that selectively secures call conversations capable of being recorded by external recording devices such as cameras and microphones based on a corresponding security policy applied to the call.

One embodiment provides a method of securing recordable call conversations. The method comprises: receiving, at an electronic computing device, a notification indicating that a call has been initiated from a first communication device to a second communication device, determining, at the electronic computing device, that conversations exchanged during the call are recordable by at least one recording device external to the first and second communication devices; identifying, at the electronic computing device, a security policy to be applied to the call between the first communication device and the second communication device; determining, at the electronic computing device, from the security policy, that there is a need to secure recording of conversations exchanged between the first and second communication devices during the call; and securing, at the electronic computing device, the conversations recordable by the at least one recording device by modifying a recording function associated with the at least one recording device for a duration of the call. The recording function of the at least recording device is modified by instructing the at least one recording device to perform one or more of: redacting audio or video recorded by the at least one recording device for the duration of the call, disabling the at least one recording device from recording audio or video for the duration of the call, or encrypting audio or video recorded by the at least one recording device for the duration of the call prior to storing or forwarding the audio or video recorded by the at least one recording device.

Another embodiment provides an electronic computing device, comprising: a communications interface; and an electronic processor communicatively coupled to the communications interface. The electronic processor configured to: receive, via the communications interface, a notification indicating that a call has been initiated from a first communication device to a second communication device, determine that conversations exchanged during the call are recordable by at least one recording device external to the first and second communication devices; identify a security policy to be applied to the call between the first communication device and the second communication device; determine, from the security policy, that there is a need to secure recording of conversations exchanged between the first and second communication devices during the call; and secure the conversations recordable by the at least one recording device by modifying a recording function associated with the at least one recording device for a duration of the call. The recording function of the at least recording device is modified by instructing the at least one recording device to perform one or more of: redacting audio or video recorded by the at least one recording device for the duration of the call, disabling the at least one recording device from recording audio or video for the duration of the call, or encrypting audio or video recorded by the at least one recording device for the duration of the call prior to storing or forwarding the audio or video recorded by the at least one recording device.

Each of the above-mentioned embodiments will be discussed in more detail below, starting with example system and device architectures of the system in which the embodiments may be practiced, followed by an illustration of processing blocks for achieving an improved technical method and device for securing recordable call conversations.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

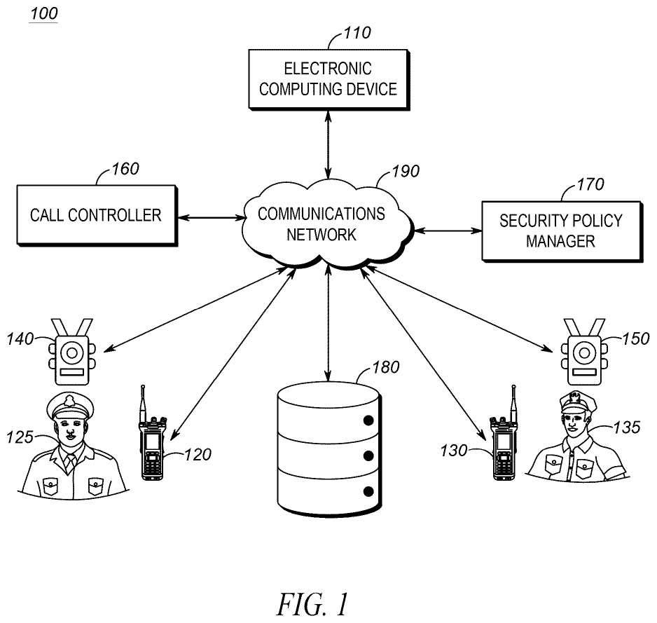

Referring now to the drawings, and in particular FIG. 1, a system 100 is shown including an electronic computing device 110, a plurality of communication devices including, for example, a first communication device 120 and a second communication device 130, one or more recording devices including, for example, a first recording device 140 and a second recording device 150, a call controller 160, a security policy manager 170, an inventory database 180, and a communications network 190. The electronic computing device 110 is any computing device configured to secure recordable call conversations. The electronic computing device 110 is implemented as a standalone electronic device or alternatively integrated into one or more other devices (e.g., call controller 160) in the system 100. In accordance with some embodiments, the electronic computing device 110 is a device particularly authorized by an agency to secure recordable call conversations initiated or accepted by one or more users associated with the agency based on security policies applied to the call. An agency is an organizational entity that may be responsible for enforcing security policies (for example, via the security policy manager 170) to be applied to conversations taking place during a call involving at least one user associated with the agency.

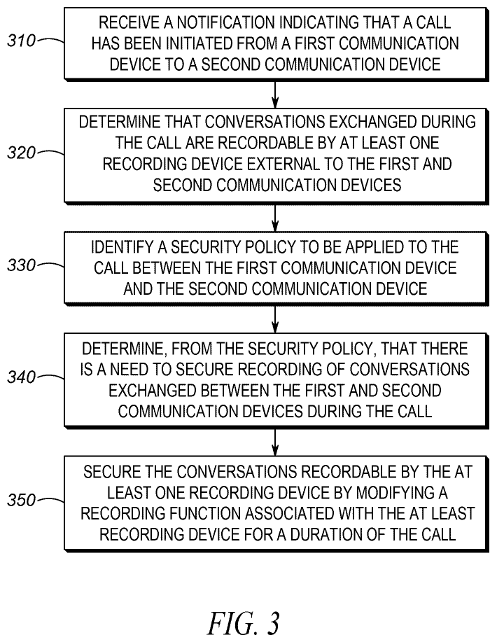

The communication devices 120, 130 may be carried or worn by respective users 125, 135, generically referred to as user(s), member(s), or participant(s) of a call. For example, the users 125, 135 may include public-safety responders, enterprise users, or other users who may be associated with agencies that require securing recordable call conversations based on security policies applied to the call. In accordance with some embodiments, the first communication device 120 may include a communication device particularly issued by an agency and/or enrolled by the agency for securing recordable conversations associated with a call that is originating from and/or terminating at the first communication device 120. In these embodiments, the second communication device 120 may similarly refer to a communication device that is issued by the same or different agency and/or enrolled by the same or different agency for securing recordable conversations associated with a call that is originating from and/or terminating at the second communication device 130. In one embodiment, not all communication devices participating in a call are issued and/or enrolled by an agency for the purpose of securing recordable call conversations. In accordance with embodiments, the process (e.g., process 300 shown in FIG. 3) of securing recordable call conversations is executed as long as at least one of the communication devices (e.g., first communication device 120) participating in a call is associated with a security policy that requires stringent security measures to be applied to the call. The communication devices 120, 130, include, but are not limited to, a battery-powered portable radio used for narrowband and/or broadband direct-mode or infrastructure communications, a battery-powered radio speaker microphone (RSM) video capture device, and vehicular radios. In one embodiment, the communication devices 120, 130 may include one or more of mobile phones, cellular phones, smart phones, laptop computers, or tablets. Each communication device 120, 130 may include one or more wireless communication interfaces for communicating with one or more other communication devices in the system 100 via the communications network 190. Although FIG. 1 shows only two communication devices 120, 130, the system 100 may include any number of communication devices participating in any number of calls.

In some embodiments, the communication devices 120, 130 may communicate with each other, and perhaps other devices accessible via other network links, using a group communications protocol over wireless link. In this embodiment, each communication device 120, 130 may be a group communication device, such as a push-to-talk device, that is normally maintained in a monitor only mode, and then switches to a transmit-only mode (i.e., half-duplex mode), or transmit and receive mode (i.e., full-duplex mode) upon depression or activation of a PTT input switch. The group communications infrastructure in the system 100 allows a single communication device, such as the first communication device 120, to initiate a group call with one or more other communication devices (e.g., the second communication device 130) associated with a particular group of communication devices at the same time. The communication devices 120, 130 and various other network devices such as the call controller 160 may cooperate to define groups of communication devices and enable the one-to-many communications feature provided by the system 100. As an example, the first and second communication devices 120, 130 may each be affiliated with a same call group or talk group.

The recording devices 140, 150 include any device that is capable of capturing audio, video, or both within its operational range. When the recording device is a video recording device, the operational range may correspond to a field of view or a visible area that the recording device can record at any given moment. When the recording device is an audio recording device, the operational range may be determined by spatial regions or directions the audio recording device can capture sound, which can be omnidirectional, unidirectional, or bidirectional. The recording devices 140, 150 may include one or more of smartphones equipped with a front or rear-facing camera or a built-in microphone, digital cameras, webcams, voice recorders, camcorders, security cameras, dashcams, body cameras, drones, or any other portable or fixed devices equipped with a camera or a microphone. In accordance with embodiments, the recording devices 140, 150 are external to, and separate from, the communication devices 120, 130 engaged in a call. In the example shown in FIG. 1, the first recording device 140 is illustrated as a body camera assigned to the first user 125 operating the first communication device 120. Similarly, the second recording device 150 is illustrated as a body camera assigned to the second user 135 operating the second communication device 130. The body cameras illustrated in FIG. 1 are located outside of the first and second communication devices 120, 130 participating in a call.

In accordance with embodiments, the electronic computing device 110 executes the process of securing recordable call conversations by instructing a recording device to modify its recording function by redacting conversations recorded during a call, disabling recording of conversations for the duration of the call, or encrypting conversations recorded during the call. As an example, a first agency (e.g., public-safety agency) looking to implement a process for securing recordable call conversations involving one or more communication devices issued and/or enrolled by the first agency may negotiate and have an agreement with one or more second agencies that own or control recording devices (e.g., security cameras) that may be placed in one or more predefined areas. The agreement between the first and second agencies may authorize a device such as the electronic computing device 110 associated with the first agency to make a request to one or more recording devices associated with the second agency to temporarily modify their recording function, for example, for a time period corresponding with a call duration. As part of the agreement, the second agency may configure the recording devices associated with the second agency to verify the authenticity of the electronic computing device 110 employed by the first agency and further comply with the request and instructions received from the electronic computing device 110 for the purpose of securing recordable call conversations involving one or more communication devices associated with the first agency.

The call controller 160 may be, for example, a radio controller, push-to-talk (PTT) server, zone controller, mobile management entity (MME), base station controller (BSC), mobile switching center, site controller, or other network device. While the call controller 160 is illustrated as a separate entity in the system 100, the call controller 160 may be integrated with other devices (e.g., electronic computing device 110) in the communications network 190. The call controller 160 is configured to manage calls, for example, by setting up, maintaining, and terminating calls between two or more communication devices 120, 130. The call controller 160 may be further configured to provide registration, authentication, encryption, routing, and other services to communication devices 120, 130 operating within the coverage area of the communications network 190. The call controller 160 may also control allocation of communication resources (e.g., frequency channels) required to establish a call between communication devices 120, 130. In embodiments where the call controller 160 supports group calls, the call controller 160 may additionally track or has access to talk group subscription information that identifies each talk group by a unique group identifier. Each group is associated with a plurality of call participants or members, where each call participant is associated with a unique identifier identifying one of a communication device such as the first communication device 120 or the user 125 operating the first communication device 120. For example, a participant associated with a call or talkgroup may be identified by a device identifier (ID) such as a hardware ID, hardware Media Access Control (MAC) address, Internet Protocol (IP) address, radio ID, International Mobile Subscriber Identity (IMSI), a serial number, user name, user ID, or some other unique identifier that can be used to identify subscribed participant communication devices 120, 130 or users 125, 135. In accordance with some embodiments, the call controller 160 is configured to send a notification to the electronic computing device 110 to indicate initiation of a call from one communication device (e.g., first communication device 120) to another communication device (e.g., second communication device 130) in the system 100. In response to receiving the notification from the call controller 160 regarding initiation of a call, the electronic computing device 110 initiates a process to determine whether the conversations exchanged during the call is recordable by at least one recording device (e.g., recording devices 140, 150) and further secure such recordable conversations based on a security policy applied to the call. The security policy applied to any given call between two or more call participants is retrieved, for example, from the security policy manager 170.

The security policy manager 170 is configured to store security policies encompassing an array of security measures designed to protect the integrity and confidentiality of communications including call conversations. The scope of such security measures include, but is not limited to, encrypting call communications to prevent eavesdropping, regularly rotating encryption keys to reduce the risk of key compromise, restricting access to keys to authorized personnel only, and employing robust key generation algorithms or hardware key source to generate encryption keys in accordance with a stringent security standard, for example, to ensure the strength and unpredictability of cryptographic keys. The security policy manager 170 is implemented as a standalone electronic device or alternatively integrated into one or more other devices (e.g., electronic computing device 110 or call controller 160) in the system 100. In accordance with some embodiments, when a call is initiated from one communication device (e.g., first communication device 120) to another communication device (e.g., second communication device 130), the call controller 160 communicates with the security policy manager 170 to retrieve a security policy that is applied to the call. The security policy manager 170 is configured to identify the applicable security policies based on one or more of user identity, device type, call type, group identifier, or network context associated with the participants of a call. For instance, a call initiated from a device enrolled for a policy that requires a higher level of encryption and more frequent key rotation may trigger application of a security policy that requires the electronic computing device 110 to secure call conversations that may be recordable by one or more of the recording devices 140, 150. The security policies may be stored in any suitable format at the security policy manager 170.

The inventory database 180 stores information corresponding to fixed or portable recording devices (e.g., recording devices 140, 150) that are capable of capturing and recording conversations exchanged during a call. The term “conversations” exchanged during a call is intended to cover (i) any speech input or audible expression provided by a first user (e.g., user 125) and captured at a microphone of a first communication device (e.g., first communication device 120) participating in a call with one or more second users (e.g., user 135) any (ii) any audio output generated corresponding to the speech input received from the first user and provided via a speaker of a second communication device (e.g., second communication device 130) for one or more of the second users to hear. In accordance with some embodiments, the inventory database 180 stores information identifying one or more recording devices (e.g., recording device 140) that are able to record the speech input or audible expression provided by the first user 125 as well as one or more recording devices (e.g., recording device 150) that are able to record the audio output generated for the one or more second users 135 to hear. In one embodiment, the inventory database 180 may include information identifying a plurality of users and/or one or more communication devices operated by such users along with information identifying one or more recording devices that are pre-assigned to each user and/or currently co-located with a communication device operated by the user during the call. In the example shown in FIG. 1, the inventory database 180 may include information indicating that the first recording device 140 (e.g., identified by device identifier of the first recording device 140) is assigned to a first user 125 (e.g., identified by a user identifier of the first user) or that the first recording device 140 is currently co-located with the first communication device 120 operated by the first user 125 during a call. As used herein, the term “co-located” indicates that a recording device identified in the inventory database 180 is located in close proximity (e.g., within a predefined distance) to a location of a communication device that is operated by a user during a call. The term “co-located” may also indicate that a recording device identified in the inventory database 180 has an operational range (e.g., field of view of a camera or spatial region for a microphone) that would make it possible for the recording device to capture and record audio or video of conversations exchanged during the call. In some embodiments, the inventory database 180 may store information indicating a list of recording devices (e.g., security cameras) that are pre-deployed corresponding to different locations. In these embodiments, the electronic computing device 110 may identify recording devices capable of recording conversations exchanged during a call based on a current location of communication devices that are participating in the call. As an example, the electronic computing device 110 may determine that the first communication device 120 participating in a call is in close proximity to the first recording device 140 (e.g., body camera operated by the user 125) based on a current location of the first communication device 120 as determined by the electronic computing device 110 and a current location of the first recording device 140 as identified in the inventory database 180. The electronic computing device 110 may similarly determine that the second communication device 130 participating in the call with the first communication device 120 is in close proximity to the second recording device 150 (e.g., body camera operated by the user 135) based on the location of the second communication device 130 as determined by the electronic computing device 110 and a current location of the second recording device 150 as identified in the inventory database 180.

The inventory database 180 is implemented using any type of storage device, storage server, storage area of network, redundant array of independent discs, cloud storage device, or any type of local or network-accessible storage device configured to store information corresponding to recording devices for access by the electronic computing device 110. In some embodiments, the inventory database 180 is a commercial cloud-based storage device. In some embodiments, the inventory database 180 is housed on suitable on-premises database servers. In one embodiment, the inventory database 180 may be stored locally at the electronic computing device 110 or at the call controller 160.

The electronic computing device 110, communication devices 120, 130, recording devices 140, 150, call controller 160, and security policy manager 170 may communicate with one another via the communications network 190. The communications network 190 may include communications infrastructure such as a base station that works in tandem with an infrastructure radio access network (RAN) (which in some embodiments include entities such as the call controller 160 and the security policy manager 170) to provide infrastructure wireless communication services to communication devices 120, 130 that are within a wireless transmission range of the base station. In some embodiments, the system 100 may include base stations, base station controllers, router, switches, gateways, and the like, arranged, connected, and programmed to facilitate calls between communication devices 120, 130. The communications network 190 could take the form of a public-safety radio network or commercial broadband network. The communications network 190 may include wireless and/or wired connections. For example, the communications network 190 may be implemented using a wide area network, such as the Internet, a local area network, such as a Wi-Fi network, and personal area or near-field networks, for example a Bluetooth™ network. Portions of the communications network may include a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, and combinations or derivatives thereof. The communications network 190 may implement one or more radio access technologies (RATs) and may communicate with communication devices 120, 130 over respective wireless or air-interface links according to the one or more RATs. Example RATs include a direct-mode, conventional, or infrastructure-mode trunked land-mobile-radio (LMR) standard or protocol such as European Telecommunications Standards Institute (ETSI) Digital Mobile Radio (DMR), a Project 25(P 25 ) standard defined by the Association of Public Safety Communications Officials International (APCO), Terrestrial Trunked Radio (TETRA), or other LMR radio protocols or standards. In other embodiments, RATs operate in accordance with standard and/or protocols such as Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application. The communication devices 120, 130 may each use the same RAT, in other embodiments, may use different RATs to communicate with one or more same or different infrastructure RAN.

Although FIG. 1 shows only one electronic computing device 110, one call controller 160, and one security policy manager 170, the system 100 may include any number of electronic computing devices 110, call controllers 160, and security policy managers 170 for securing recordable call conversations between any number of participants participating in any number of calls.

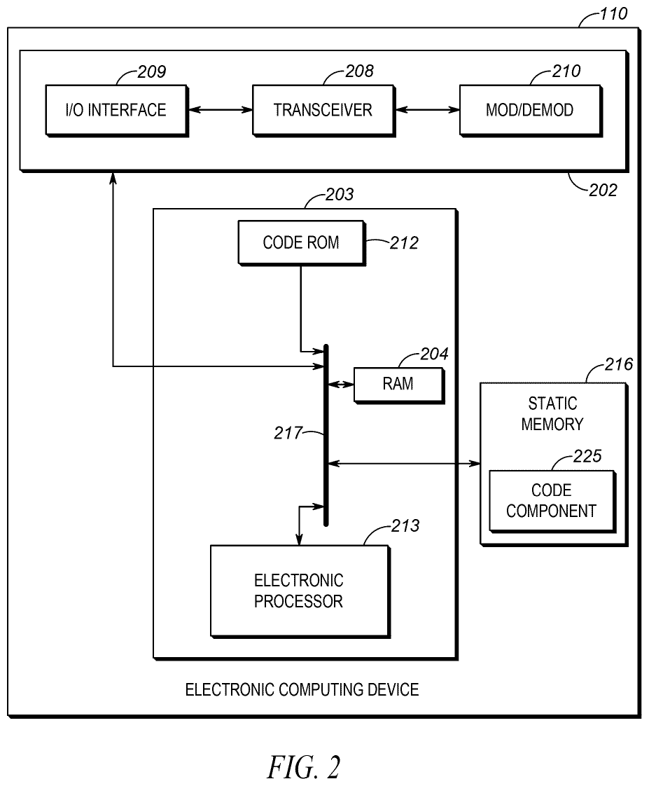

FIG. 2 is an example functional block diagram of an electronic computing device 110 operating within the system 100 in accordance with some embodiments. The electronic computing device 110 may be embodied in computing devices not illustrated in FIG. 1, and/or may be a distributed computing device across two or more of the foregoing (or multiple of a same type of one of the foregoing) and linked via a wired and/or wireless communication link(s). In one embodiment, one or more functions of the electronic computing device 110 are implemented within the call controller 160 shown in FIG. 1. While FIG. 2 represents an electronic computing device 110 described above with respect to FIG. 1, the electronic computing device 110 may include fewer or additional components in configurations different from that illustrated in FIG. 2.

As shown in FIG. 2, the electronic computing device 110 includes a communications interface 202 coupled to a common data and address bus 217 of a processing unit 203. The communications interface 202 sends and receives data to and from other devices in the system 100. The communications interface 202 may include one or more wired and/or wireless input/output (I/O) interfaces 209 that are configurable to communicate with other devices (e.g., call controller 160, security policy manager 170, and recording devices 140, 150) in the system 100. For example, the communications interface 202 may include one or more wireless transceivers 208, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network. The communications interface 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The processing unit 203 may include an encoder/decoder with a code Read Only Memory (ROM) 212 coupled to the common data and address bus 217 for storing data for initializing system components. The processing unit 203 may further include an electronic processor 213 (for example, a microprocessor, a logic circuit, an application-specific integrated circuit, a field-programmable gate array, or another electronic device) coupled, by the common data and address bus 217, to a Random Access Memory (RAM) 204 and a static memory 216. The electronic processor 213 may generate electrical signals and may communicate signals through the communications interface 202.

Static memory 216 may store operating code 225 for the electronic processor 213 that, when executed, performs one or more of the blocks set forth in FIG. 3, and the accompanying text(s). The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like.

In accordance with embodiments, the electronic processor 213 implemented at the electronic computing device 110 secures conversations recordable by at least one recording device (e.g., recording devices 140, 150) by modifying a recording function associated with the at least recording device for a duration of the call. The recording function may be modified by either redacting audio or video recorded by the at least recording device for the duration of the call or by disabling the at least one recording device from recording audio or video for the duration of the call or by encrypting audio or video recorded by the at least recording device for the duration of the call.

In accordance with some embodiments, the electronic computing device 110 further includes or otherwise is communicatively coupled to a visual and/or audio output device (not shown). For example, the visual and/or audio output device may include an electronic display and/or a speaker. A visual output in the form of text, image, or video may be rendered via the electronic display of the visual and/or audio output device. An audio output in the form of audio is played back via the speaker of the one or more computing devices associated with the users. The visual and/or audio output may include information indicating that conversations exchanged during a particular call between two or more identified participants and recordable by one or more recording devices have been secured. The visual and/or audio output may additionally identify one or more recording devices which have been instructed by the electronic computing device 110 to modify their recording function for the purpose of securing conversations exchanged during the call. The visual and/or audio output may also include recording of call conversations that are encrypted or redacted by one or more of recording devices 140, 150.

Turning now to FIG. 3, a flowchart diagram illustrates a process 300 for securing recordable call conversations in accordance with some embodiments. While a particular order of processing steps, message receptions, and/or message transmissions is indicated in FIG. 3 as an example, timing and ordering of such steps, receptions, and transmissions may vary where appropriate without negating the purpose and advantages of the examples set forth in detail throughout the remainder of this disclosure. An electronic computing device 110 shown in FIG. 1 and/or FIG. 2, and embodied as a singular computing device or distributed computing device may execute process 300 via an electronic processor 213.

The electronic computing device 110 may execute the process 300 at power-on, at some predetermined periodic time period thereafter, in response to a trigger raised locally at the electronic computing device 110 via an internal process or via an input interface or in response to a trigger from an external device (e.g., a user may use an external computing device to request the electronic computing device 110 to initiate the process 300) to which the electronic computing device 110 is communicably coupled, among other possibilities. As an example, the electronic computing device 110 is programmed to automatically trigger execution of the process 300 in response to detecting that a calling party has initiated a call.

The process 300 of FIG. 3 need not be performed in the exact sequence as shown and likewise various blocks may be performed in different order or alternatively in parallel rather than in sequence. The process 300 may be implemented on variations of the system 100 of FIG. 1 as well.

At block 310, the electronic computing device 110 receives a notification indicating that a call has been initiated from a first communication device 120 to one or more other communication devices including, for example, a second communication device 130. In accordance with some embodiments, the electronic computing device 110 receives the notification from the call controller 160 when a call is initiated from one communication device to one or more other communication devices. In one embodiment, when a call is initiated by a user 125 (e.g., by depressing a PTT key) on the first communication device 120, the call controller 160 receives a signal indicating the user's 125 intention to establish a communication link with the second communication device 130. The signal received at the call controller 160 may include, among other things, source address corresponding to the first communication device 120, destination address corresponding to the second communication device 130 and the type of call being requested, whether it is a full duplex call, or a half-duplex PTT call. Upon receiving the initiation signal, the call controller 160 processes the request, sets up the appropriation communication channel, and orchestrates the necessary resources to establish the call. The call controller 160 then signals one or more receiving communication devices such as the second communication device 120 (e.g., based on the destination addresses), facilitating the connection and managing the call state throughout the duration of the interaction. In accordance with some embodiments, the call controller 160, in addition to facilitating the connection between the first and second communication devices 120, 130, concurrently sends a notification to the electronic computing device 110 indicating that a call has been initiated from the first communication device 120 to the second communication device 120. The notification may include, among other things, information identifying (i) the first communication device 120 or the user 125 operating the first communication device 120 at which a call been initiated, (ii) the second communication device 130 or the user 135 operating the second communication device 130 at which the call will be accepted and (ii) current locations (e.g., GPS coordinates) of the first and second communication devices 120, 130 and/or of the users 125, 135 respectively operating the first and second communication devices 120, 130.

At block 320, the electronic computing device 110 determines that conversations exchanged during the call are recordable by at least one recording device external to the first and second communication devices 120, 130. The conversations recordable by at least one recording device may include one or more of the following: (i) any speech input or audible expression provided by the first user 125 operating the first communication device 120 and captured at a microphone of the first communication device 120, (ii) any audio output generated corresponding to the speech input received from the first user 125 and provided via a speaker of the second communication device 130 for the second user 135 to hear, (iii) any speech input or audible expression provided by the second user 135 operating the second communication device 130 and captured at a microphone of the second communication device 130, or (iv) any audio output generated corresponding to the speech input received from the second user 135 and provided via a speaker of the first communication device 120 for the first user 125 to hear. The conversations including speech input or audio output captured corresponding to either parties (i.e., users 125, 135) participating in the call may be recordable by the at least recording device in an audio or video format.

In accordance with some embodiments, in response to receiving a notification indicating that the first communication device 130 has initiated a call to the second communication device 130, the electronic computing device 110 retrieves, from the notification, information corresponding to the communication devices (or of the users operating the respective communication devices) that will be participating in the call. The information may include device identifiers uniquely identifying the respective first and communication devices 120, 130 and/or user identifiers uniquely identifying the respective users 125, 135 of the first and second communication devices 120, 130. The electronic computing device 110 then transmits a query to the inventory database 180 to request the inventory database to retrieve information identifying recording devices that are capable of recording conversations at either end of the first communication device 120 or the second communication device 130. The query to the inventory database 180 may include device identifiers uniquely identifying the respective first and communication devices 120, 130 and/or user identifiers uniquely identifying the respective users 125, 135 of the first and second communication devices 120, 130. In response, the inventory database 180 retrieves one or more recording devices (e.g., the first recording device 140 or body camera) that have been pre-assigned to the user 125 operating the first communication device 120 as well as one or more recording devices (e.g., the second recording device 150 or body camera) that have been pre-assigned to the user 135 operating the second communication device 130. In one embodiment, the query to the inventory database may additionally or alternatively include current locations of the first communication device 120 and the second communication device 130 (e.g., GPS locations of the first and second communication devices 120, 130 as included in the notification received by the electronic computing device 110). In this embodiment, the inventory database 180 may additionally identify recording devices (e.g., security cameras) that are co-located with the first or second communication devices 120, 130 by comparing the current locations of the first or second communication devices 120, 130 and locations of recording devices (e.g., locations periodically updated by the recording devices or another device having access to information regarding the locations of the recording devices).

As described previously, the at least one recording device determined at block 320 as being capable of recording the conversations exchanged during the call may include any audio or video recording device that may be pre-assigned to users 125, 135 of the first and second communication devices 120, 130 or any audio or video recording devices that may be co-located with the first and second communication devices 120, 130. A co-located recording device may include a recording device identified by the electronic computing device 110 as being located in close proximity (e.g., 1-15 feet) to a location of the first or second communication devices 120, 130. A co-located recording device may also include a recording device identified by the electronic computing device 110 as having an operational range (e.g., field of view of a camera or spatial region for a microphone) that would enable the recording device to effectively capture and record speech input received from a speech source (e.g., user 125 or user 135) at the first communication device 120 or the second communication device 130 and/or a speech output generated at a speech output device (e.g., speaker) implemented at the first communication device 120 or the second communication device 130.

At block 330, the electronic computing device 110 identifies a security policy to be applied to the call between the first communication device 120 and the second communication device 130. In accordance with some embodiments, the electronic computing device 110 transmits a query to the security policy manager 170 requesting the security policy applied to the call. The query may include, among other things, information identifying one or more of (i) the first communication device 120 at which the call has been initiated, (ii) the second communication device 130 at which the call will be accepted, (iii) information identifying the users 125, 135 respectively operating the first and second communication devices 120, 130 that will be participating in the call, (iii) call type (e.g., half-duplex or full-duplex), (iv) group identifier, if first and second communication devices 120, 130 are members of a talk group, and (v) network context (e.g., private or public network). In response to receiving the query, the security policy manager 170 identifies applicable security policies applied to the call as a function of one or more of user identity, device type, call type, group identifier, and network context associated with the first and the second communication devices 120, 130 that will be participating in the call. The security policy manager 170 then transmits a response including information associated with the security policy applied to the call. The information associated with the security policy applied to the call includes one or more security measures that will be applied to the communications transmitted between the first and second communication devices 120, 130 during the call. The security measures, may include, but are not limited to, encrypting communications transmitted during the call, regularly rotating the encryption keys used to encrypt communications transmitted during the call, restricting access to the encryption keys to a limited number of authorized users, employing complex key generation algorithms (e.g., using varying key lengths such as a 128-bit or 256 bit) or key sources to generate encryption keys, for example, to comply with a predefined security standard (e.g., FIPS or federal information processing standard certification levels), and implementing end-to-end encryption for the call. The above security measures are only provided as examples and that any number of other security measures can be included in the security policies to be applied to a call between communication devices. In some embodiments, the security policy may not include any security measures to be applied to the call conversations between the first and second communication devices 120, 130.

At block 340, the electronic computing device 110 determines, from the security policy identified at block 330, that there is a need to secure recording of conversations exchanged between the first and second communication devices 120, 130 during the call. In accordance with some embodiments, the electronic computing device 110 receives a response from the security policy manager 170 with information associated with the security policy applied to the call. The electronic computing device 110 identifies, from the security policy, one or more security measures implemented at the first communication device 120 or the second communication device 130 for the duration of the call. The electronic computing device 110 then determines that there is a need to secure recording of conversations exchanged between the first and second communication devices during the call based on the one or more security measures. If the security measures implemented for securing the call is higher than a security threshold, then the electronic computing device 110 determines that there is a need to secure not only the conversations transmitted on a communication channel established corresponding to the call between the first and second communication devices 120, 130, but also any conversations that are recordable by one or more recording devices that are located externally from the first and second communication devices 120 and 130 participating in the call. In this case, the electronic computing device 110 proceeds to block 350 to secure the conversations that may be recordable by the one or more recording devices. On the other hand, if the security measures implemented for securing the call are not higher than the security threshold, then the electronic computing device 110 determines that there is no need to secure call conversations that are recordable by one or more recording devices. In this case, the electronic computing device 110 stops the execution of the process 300 at block 340 without securing the recordable call conversations. In other words, in some embodiments, the electronic computing device 110 does not secure recordable call conversations where no security policy is enforced for securing a call.

In one embodiment, the electronic computing device 110 determines that the security measures implemented for securing the call are higher than a security threshold when the electronic computing device determines, from the security measures, one or more of: (i) that the security policy requires the first communication device 120 or the second communication device 130 to encrypt communications transmitted during the call, (ii) that the security policy requires the first communication device 120 or the second communication device 130 to rotate an encryption key used for encrypting communications transmitted during the call on a periodic basis, (iii) that an encryption key used for encrypting the call is restricted for access by a limited number of users (e.g., less than a threshold number of users), and (iv) that one of an algorithm or a key source used to generate the encryption key meets a stringent security standard (e.g., FIPS 140-3 certification level). On the other hand, in this embodiment, the electronic computing device 110 may determine that the security measures implemented for securing the call are not higher than the security threshold when the electronic computing device 110 determines, from the security measures (i) that there is no requirement for the first or second communication devices 120, 130 to encrypt communications transmitted during the call, (ii) that there is no requirement for rotating an encryption key used for encrypting communications transmitted during the call, (iii) that there is no requirement for restricting access to the encryption key to a limited number of users, or (iv) that there is no requirement for an algorithm or a key source used to generate the encryption key to meet a stringent security standard.

In any case, after determining that there is a need to secure recording of conversations exchanged between the first and second communication devices 120, 130 during the call, the electronic computing device 110 proceeds to block 350 to secure the conversations recordable by the at least one recording device (as determined at block 320) by modifying a recording function associated with the at least one recording device for a duration of the call.

In accordance with some embodiments, before proceeding to secure the conversations, the electronic computing device 110 identifies (e.g., at block 330) the at least one recording device based on whether the at least one recording device is capable of recording the conversations at either end of the first communication device 120 or the second communication device 130. As an example, the electronic computing device 110 may determine that the conversations are recordable by two recording devices i.e., the first recording device 140 (e.g., body camera) assigned to the first user 125 operating the first communication device 120, and the second recording device 150 (e.g., body camera) assigned to the second user 135 operating the second communication device 130. As another example, the electronic computing device 110 may determine that the conversations are recordable by two recording devices i.e., the first recording device 140 co-located with the first communication device 120 and the second recording device 150 co-located with the second communication device. In this example, the electronic computing device 110 may determine that the first recording device 140 is co-located with the first communication device 120 based on the operational range of the recording device. The operational range may correspond to a field of view of a camera or a spatial region within which the microphone can effectively capture and record (i) any speech input or audible expression provided by the first user 125 operating the first communication device 120 and (ii) any audio output generated corresponding to the speech input received from the second user 135 operating the second communication device 130 and provided via the speaker of the first communication device 120. Alternatively, the electronic computing device 110 may determine that the first recording device 140 is co-located with the first communication device 120 by comparing a location of the first recording device 140 with a location of the first communication device 120. If the distance between the locations are within a predetermined distance (e.g., 15 feet or less), then the electronic computing device 110 determines that the first recording device 140 is co-located with the first communication device 120. Similarly, the electronic computing device 110 may determine that second recording device 150 is co-located with the second communication device 130 based on the operational range of the second recording device 150 to effectively capture and record (i) any speech input or audible expression provided by the second user 135 operating the second communication device 130 and (ii) any audio output generated corresponding to the speech input received from the first user 125 operating the first communication device 120 and provided via the speaker of the second communication device 130. Alternatively, the electronic computing device 110 may determine that the second recording device 150 is co-located with the second communication device 130 by comparing a location of the second recording device 150 with a location of the second communication device 130. If the distance between the locations are within a predetermined distance (e.g., 15 feet or less), then the electronic computing device 110 determines that the second recording device 150 is co-located with the second communication device 130.

After identifying the at least one recording device (e.g., first recording device 140 and/or second recording device 150) capable of recording the conversations exchanged during the call between the first and second communication devices 120, 130, the electronic computing device 110 secures the conversations recordable by the at least one recording device by modifying a recording function associated with the at least one recording device for a duration of the call. In accordance with some embodiments, the electronic computing device 110 transmits an electronic signal requesting the first and second recording devices 140, 150 to modify their recording functions as indicated in the electronic signal. In response, the first and recording devices 140, 150 verify if the electronic computing device 110 is authorized to make a request to modify their recording function and in response, upon verification, proceeds to modify their recording functions as indicated in the electronic signal. As an example, a regular recording function (i.e., before modification) performed at a recording device may include capturing, recording, and storing (e.g., in an unencrypted or unredacted form) an audio or video of speech input or audible expression received from a speech source (e.g., users 125, 135) participating in a call via the first or second communication devices 120, 130 or speech output produced via a speaker of the first or second communication devices 120, 130. In contrast, the modified recording function performed at a recording device may include one or more of: (i) redacting audio or video recorded by the recording device for the duration of the call, (ii) disabling the recording device from recording audio or video for the duration of the call, or (iii) encrypting audio or video recorded by the recording device for the duration of the call prior to storing or forwarding the audio or video recorded by the recording device.

In one embodiment, the electronic computing device 110 transmits an electronic signal requesting the at least one recording device identified at block 320 to modify a recording function associated with the at least one recording device by redacting audio or video recorded by the at least one recording device for the duration of the call. The electronic signal may include instructions commanding the recording device to redact audio or video recorded for the duration of the call. The instruction may include a type of redaction to be applied to the recorded audio or video. The instructions may also include authentication information associated with the electronic computing device 110 to enable the recording device to verify that the command to request redaction is received from an authorized device. Prior to receiving the request from the electronic computing device 110, the at least one recording device may be operating in a regular recording function mode by recording audio or video captured from the environment and storing the audio or video in an unredacted form. However, after receiving the request from the electronic computing device 110, the at least one recording device modifies its recording function by particularly redacting any audio or video recorded by the at least one recording device for the duration of the call. The at least one recording device may redact audio or video recorded by the at least recording device for the duration of the call using any redaction techniques known in the art.

As an example, the at least one recording device may perform redaction of audio by detecting speech in one or more segments of the audio or video recorded by the at least one recording device and by further removing, muting, or distorting the specific segments of the audio or video in which speech is detected. After redacting the audio or video recorded during the duration of the call, the at least one recording device forwards the redacted audio or video on a dedicated communication channel with restricted access. The information regarding the communication channel to be used by the recording device to stream the redacted audio or video may be identified in the instructions included in the electronic signal sent from the electronic computing device 110 to the recording device. The at least one recording device may perform redaction of video by detecting a speech source visually captured in one or more segments of the video recorded by the at least one recording device and further obscuring (e.g., by one or more of pixelation, blurring, masking, removing, or resizing the particular segments of the video) the speech source (entirely or partially) visually captured in the one or more segments of the video recorded by the at least one recording device. As an example, the speech source may include a first user 125 operating the first communication device 120 or a second user 135 operating the second communication device. In this example, the first recording device 140 obscures a lip movement (e.g., by blurring pixels capturing the lip movement) detected corresponding to the first user 125 in one or more segments of the video recorded by the first recording device 140 during the call. The second recording device 150 similarly obscures a lip movement detected corresponding to the second user 135 in one or more segments of the video recorded by the second recording device 150 during the call. Obscuring the lip movement anonymizes any sensitive information captured from speech input or audible expression received from the first user 125 or the second user 135 when the first user 125 and second 135 participates in a call via the respective first communication device 120 and the second communication device 130. The first recording device 140 and the second recording device 150 continues to redact any video or audio recorded by the respective recording devices 140, 150 until the respective recording devices 140, 150 receive another electronic signal from the electronic computing device 110 indicating that the call between the first and second communication devices 120, 130 has ended. In other words, after the call has ended, each of the first and second recording devices 140, 150 switches its operation from the modified recording function mode to the regular recording function mode.

In another embodiment, the electronic computing device 110 transmits an electronic signal requesting the at least one recording device identified at block 320 to modify a recording function associated with the at least one recording device by disabling the at least one recording device from recording audio or video for the duration of the call. In this embodiment, the electronic signal may carry instructions commanding the recording device to cease recording, for example, by powering down the image or audio sensor integrated into the recording device, or to enter a stand-by-mode. The instructions may also include authentication information associated with the electronic computing device 110 to enable the recording device to verify that the command to disable the at least recording device is received from an authorized device. Prior to receiving the request from the electronic computing device 110, the recording device may be operating in a regular recording function mode by recording and storing audio or video captured from the environment. However, after receiving the request from the electronic computing device 110, the at least one recording device modifies its recording function by disabling its recording function for the duration of the call to ensure that call conversations are not digitally stored anywhere. In one embodiment, the recording device continues to disable its recording function until the recording device receives another electronic signal from the electronic computing device 110 indicating that the call between the first and the second communication devices 120, 130 has ended. In other words, after the call has ended, each of the first and second recording devices 140, 150 switches its operation from the modified recording function mode to the regular recording function mode. In the regular recording function mode, the first and second recording devices 140, 150 may, for example, each power up the image or audio sensor respectively integrated into the recording devices 140, 150 to reactivate recording of audio or video captured from the environment.

In another embodiment, the electronic computing device 110 transmits an electronic signal requesting the at least one recording device identified at block 320 to modify a recording function associated with the at least one recording device by encrypting audio or video recorded by the at least one recording device for the duration of the call prior to storing or forwarding the audio or video recorded by the at least one recording device. The electronic signal may include instructions commanding the recording device that encryption is to be applied to any data recorded by the at least one recording device for the duration of the call. The instruction may optionally include information corresponding to an encryption algorithm to be used for encrypting the recorded audio or video, key information including an encryption key to be used for encrypting the recorded audio or video, and security certificates or other authentication methods to confirm the identity of the electronic computing device 110 requesting encryption. Prior to receiving the request from the electronic computing device 110, the recording device may be operating in a regular recording function mode by recording audio or video captured from the environment and storing the audio or video in an unencrypted form. However, after receiving the request from the electronic computing device 110, the at least one recording device modifies its recording function by encrypting the audio or video recorded during the duration of the call using instructions (e.g., encryption key) included in the electronic signal received from the electronic computing device 110. In one embodiment, the recording device continues to encrypt any audio or video recorded by the recording device until the recording device receives another electronic signal from the electronic computing device 110 indicating that the call between the first and second communication device 120, 130 has ended. After encrypting the audio or video recorded during the duration of the call, the at least one recording device may store the encrypted audio or video in a database that is accessible to the electronic computing device 110 and/one or more users authorized by an agency which requested the electronic computing device 110 to secure call conversations. The at least one recording device additionally or alternatively forwards the encrypted audio or video on a dedicated communication channel with restricted access. The information regarding the dedicated communication channel to be used by the recording device to stream the encrypted audio or video may be identified in the instructions included in the electronic signal sent from the electronic computing device 110 to the at least one recording device.

The embodiments described herein can be advantageously implemented for securing call conversations that are recordable by externally located recording devices (i.e., recording devices that are external to and separate from the devices participating in the call) such as body cameras or security cameras. As an example, body-worn cameras or security cameras can pick up audio or video of conversations from users participating in a call. Oftentimes, security policies are enforced to require conversations exchanged during certain calls (e.g., as a function of user ID, device ID, call type, or network context) to be secured by security measures that may range from the use of encryption keys to be used for encrypting calls to the manner in which such encryption keys used for encrypting calls are generated, stored, or accessible. The embodiments described herein automatically recognize calls that are required to be protected by strong security measures and provides an additional layer of security to calls by instructing externally deployed recording devices located in proximity to parties involved in the call to modify their recording function to prevent unauthorized users from accessing call recordings that may potentially contain personal or sensitive information.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ...a”, “has ...a”, “includes ...a”, “contains ...a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate element or device via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of securing recordable call conversations, the method comprising:
receiving, at an electronic computing device, a notification indicating that a call has been initiated from a first communication device to a second communication device,
determining, at the electronic computing device, that conversations exchanged during the call are recordable by at least one recording device external to the first and second communication devices;
identifying, at the electronic computing device, a security policy to be applied to the call between the first communication device and the second communication device;
determining, at the electronic computing device, from the security policy, that there is a need to secure recording of conversations exchanged between the first and second communication devices during the call; and
securing, at the electronic computing device, the conversations recordable by the at least one recording device by modifying a recording function associated with the at least one recording device for a duration of the call.

2. The method of claim 1, wherein modifying the recording function comprises one or more of:
redacting audio or video recorded by the at least one recording device for the duration of the call,
disabling the at least one recording device from recording audio or video for the duration of the call, or
encrypting audio or video recorded by the at least one recording device for the duration of the call prior to storing or forwarding the audio or video recorded by the at least one recording device.

3. The method of claim 2, further comprising:
forwarding one of the redacted audio or video or the encrypted audio or video on a dedicated communication channel.

4. The method of claim 2, wherein redacting comprises:
detecting speech in one or more segments of the audio or video recorded by the at least one recording device; and
muting the speech detected in the one or more segments of the audio recorded by the at least one recording device.

5. The method of claim 2, wherein redacting comprises:
detecting a speech source visually captured in one or more segments of the video recorded by the at least one recording device; and
obscuring the speech source visually captured in the one or more segments of the video recorded by the at least one recording device.

6. The method of claim 5, wherein the speech source includes a first user operating the first communication device or a second user operating the second communication device.

7. The method of claim 6, wherein obscuring comprises obscuring a lip movement detected corresponding to the first user or the second user.

8. The method of claim 1, wherein identifying the security policy comprises:
transmitting, at the electronic computing device, to a security policy manager, a query requesting the security policy applied to the call; and
receiving, at the electronic computing device, a response including information associated with the security policy from the security policy manager.

9. The method of claim 1, wherein receiving the notification comprises:
receiving the notification from a call controller configured to establish the call between the first communication device and the second communication device.

10. The method of claim 1, wherein the at least one recording device comprises a first recording device co-located with the first communication device and a second recording device co-located with the second communication device.

11. The method of claim 10, wherein the first recording device is a body camera associated with a first user operating the first communication device and the second recording device is a body camera associated with a second user operating the second communication device.

12. The method of claim 1, wherein determining that conversations exchanged between the first and the second communication devices during the call is recordable by at least one recording device comprises:
identifying a first user operating the first communication device;
identifying a second user operating the second communication device; and
determining that the at least one recording device is assigned to the first user operating the first communication device or the second user operating the second communication device.

13. The method of claim 1, wherein determining that conversations exchanged between the first and the second communication devices during the call is recordable by at least one recording device comprises:
identifying a first location of the first communication device;
identifying a second location of the second communication device; and
determining that the at least one recording device is co-located with the first communication device or the second communication device by comparing a location of the at least one recording device with the first location of the first communication device and the second location of the second communication device.

14. The method of claim 1, further comprising:
identifying, from the security policy, one or more security measures implemented at the first communication device or the second communication device, and
determining that there is a need to secure recording of conversations exchanged between the first and second communication devices during the call based on the one or more security measures.

15. The method of claim 14, identifying the one or more security measures comprises:
determining that the security policy requires the first communication device or the second communication device to encrypt communications transmitted during the call;
determining that the security policy requires the first communication device or the second communication device to rotate an encryption key used for encrypting communications transmitted during the call on a periodic basis;
determining that an encryption key used for encrypting the call is restricted for access by less than a threshold number of users; and
determining that one of an algorithm or a key source used to generate the encryption key complies with a predefined security standard.

16. An electronic computing device, comprising:
a communications interface; and
an electronic processor communicatively coupled to the communications interface, the electronic processor configured to:
receive, via the communications interface, a notification indicating that a call has been initiated from a first communication device to a second communication device,
determine that conversations exchanged during the call are recordable by at least one recording device external to the first and second communication devices;
identify a security policy to be applied to the call between the first communication device and the second communication device;
determine, from the security policy, that there is a need to secure recording of conversations exchanged between the first and second communication devices during the call; and
secure the conversations recordable by the at least one recording device by modifying a recording function associated with the at least one recording device for a duration of the call.

17. The electronic computing device of claim 16, wherein the electronic processor is configured to:
transmit, via the communications interface, an electronic signal instructing the at least one recording device to modify the recording function by performing one or more of redacting audio or video recorded by the at least one recording device for the duration of the call, disabling the at least one recording device from recording audio or video for the duration of the call, or encrypting audio or video recorded by the at least one recording device for the duration of the call prior to storing or forwarding the audio or video recorded by the at least one recording device.

18. The electronic computing device of claim 16, wherein the electronic processor is configured to:
transmit, via the communications interface, to a security policy manager, a query requesting the security policy applied to the call; and
receive, via the communications interface, a response including information associated with the security policy from the security policy manager.

19. The electronic computing device of claim 16, wherein the at least one recording device comprises a first recording device co-located with the first communication device and a second recording device co-located with the second communication device.

20. The electronic computing device of claim 16, wherein the electronic processor is configured to:
identify a first user operating the first communication device;
identify a second user operating the second communication device; and
determine that the at least one recording device is assigned to the first user operating the first communication device or the second user operating the second communication device.
